(19) United States
(12) Patent Application Publication
(10) Pub. No.: US 2020/0079588 A1
(43) Pub. Date: Mar. 12, 2020

(54) AUTONOMOUS TOOL AND COMPONENT CRIB SYSTEM SYSTEM

(71) Applicant: Storeroom Logix, LLC, Greensboro, NC (US)

(72) Inventors: Brad McCormick, Greensboro, NC (US); Andrea Mainiero, Greensboro, NC (US)

(73) Assignee: Storeroom Logix, LLC, Greensboro, NC (US)

(21) Appl. No.: 16/566,270

(22) Filed: Sep. 10, 2019

Related U.S. Application Data
(60) Provisional application No. 62/729,680, filed on Sep. 11, 2018.
(60) Provisional application No. 62/810,064, filed on Feb. 25, 2019.
(60) Provisional application No. 62/810,099, filed on Feb. 25, 2019.
(60) Provisional application No. 62/849,732, filed on May 17, 2019.

(51) Int. Cl. B65G 1/04; B65G 1/12; B65G 1/137

(52) U.S. Cl. CPC B65G 1/0485; B65G 1/12; B65G 1/137; B65G 2203/042; B65G 2203/0258; B65G 2203/0233; B65G 2201/02

(57) ABSTRACT

An autonomous crib system. The system includes a storage unit having a series of shelves and a plurality of bins on each shelf adapted to receive items to be stored and to be retrieved. A locator is associated with each bin for assisting a user with identifying a bin containing a desired item to be retrieved and a counter is associated with each bin for measuring the quantity of the items stored in the bin. A hub is adapted to actuate the locator based on user input on an item to be retrieved and to provide item information based on quantity information received from the counters. The system may further include a management system adapted to manage inventory within the storage unit by storing information for each item and updating information for each item based on quantity information received from the counters by the hub.

### RELATED APPLICATIONS

The following application claims priority to U.S. Provisional Application No. 62/729,680 filed Sep. 11, 2018, U.S. Provisional No. 62/810,064 filed Feb. 25, 2019, U.S. Provisional No. 62/810,099 filed Feb. 25, 2019 and U.S. Provisional No. 62/849,732 filed May 17, 2019, each of the disclosures of which are incorporated by reference in their entireties.

### BACKGROUND

### Field

The present inventions relate generally to crib systems and, more particularly, to an autonomous crib system adapted to store and manage inventory within one or more storage units.

### Related Art

Storage units are typically used to keep maintenance, repair, operational (MRO) and/or frequently used items organized and accessible for the end-users and can be found in manufacturing plants, machine shops, OEM and panel builder facilities. Storage units can be located on the plant floor placed at or close to the point of use for convenient access or be placed in a central stores or crib area dedicated for inventory.

MRO inventory tends to be low cost, consumable items so purchasing departments will buy in bulk to prevent daily purchase orders for low cost items. Additionally the end-users of these items (maintenance/operational employees, panel builders, machine builders) expect to have enough of these items on hand so they can execute their daily tasks. In many cases, jobs or maintenance activities can be delayed due to item shortage limiting the company's production and profitability.

High dollar, critical spares and assets are normally not kept with these MRO items in fear of theft or misplacement. Due to the popularity and ease of use of online resell sites, companies are more conscious of the threat of pilferage and resell by their employees or outside contractors working in the facility. As a result these items are typically kept in a remote areas of the plant in a storeroom or crib that is either locked or manned by an employee. Some end-users utilize carousel or helix style vending machines to secure inventory. While these offer security, only certain items fit into these machines. Many items are too big for either style machines while other items may be too small thus requiring pre-packaging resulting in waste and extra work for the reseller or distributor.

As manufacturing facilities adopt lean management principles, they rely more on their distributors to manage the inventory (referred to as vendor managed inventory or VMI). In many cases end-users do not have time to keep all of their inventory organized, count inventory levels, reorder items and replenish delivered inventory. The distributors will offer to provide their VMI services and be responsible for one, many or all of the aforementioned inventory tasks. Distributors will normally offer these services for free in exchange for the guarantee replenishment business. This arrangement is normally a win-win for both parties creating a long-lasting partnership and often times opens the doors for new opportunities for cost savings and sales growth.

End-users typically do not have good clean usage data for their inventory and thus do not know how many of each item to keep on hand. End-users also do not have an easy way to determine where inventory items are used in their plant or by department. Distributors also do not have a good way to offer this information as well as other important data such as their stocking levels, lead times, mean time between failures (MTBF), etc. to the end-user at the point of purchase. Thus, end-users make uneducated decisions about how many of an item they should keep on hand, causing inventory to be under or overstocked which leads to downtime or dead inventory for the end-user.

Thus, there remains a need for an improved crib system that is adapted to operate autonomously to store and to retrieve items while, at the same time, provides item information which may be used to manage inventory within one or more storage units.

### SUMMARY

The present inventions are directed to an autonomous crib system including a storage unit having a series of shelves and a plurality of bins on each shelf adapted to receive items to be stored and to be retrieved, each bin comprising a tray mounted onto one or more weight sensors. A locator may be associated with each bin for assisting a user with identifying a bin containing a desired item to be retrieved and a counter may be associated with each bin for measuring the quantity of items based on a weight of items on the tray mounted onto one or more weight sensors. A hub may be adapted to actuate the locator based on user input on an item to be retrieved and to provide item information based on quantity information received from the counters. The system may further include a management system adapted to manage inventory within the storage unit by storing information for each item and updating information for each item based on quantity information received from the counters by the hub.

In one embodiment, the hub is adapted to display an exact quantity of items stored within each bin based on the weight of items on the tray. The hub may be adapted to determine whether a misplaced item is placed onto the bin. The hub may also be adapted to detect a low item quantity when the weight of items as determined by the weight sensor is below a threshold number of items. The hub may also relay the low item quantity from the weight sensor to the management system.

The tray may be adapted to be unmounted from the weight sensor and adapted to be mounted onto another weight sensor within the storage unit. In one embodiment, the tray is mounted directly onto the weight sensor. In another embodiment, the weight sensor further includes a platform for the tray to mount onto. For example, the tray may be mounted onto the platform via a fastener.

The tray may also be mounted onto multiple weight sensors for larger sized items. For example, the tray may be mounted onto two weight sensors.

In one embodiment, the management system manages inventory for a plurality of cribs. The plurality of cribs may be onsite. Alternatively, one or more of the plurality of cribs may be located offsite.

The crib system may further include a dynamic on-hand inventory system adapted to calculate an on-hand inventory quantity of an item on an interval based on a plurality of variables. In one embodiment, the plurality of variables is selected from an item usage history, an item stock from a vendor, a product criticality to a customer, a lead time, an average time until failure for the item, an average number of delivery days, and combinations thereof. The dynamic on-hand inventory system may be adapted to calculate the reorder quantity when the counter indicates a quantity of an item is below the on-hand inventory quantity. For example, the interval may be one month. In addition, dynamic on-hand inventory system may be adapted to retrieve and manage data from a plurality of vendors. In one embodiment, the dynamic on-hand inventory system is integrated with a vendor system for sending and retrieving data via an application programming interface. In addition, the item may be automatically transacted based on the on-hand inventory quantity when the counter indicates the quantity of an item is below the on-hand inventory quantity.

The system may further include a lock system adapted to secure items within the storage unit. In one embodiment, the lock system comprises a door on each shelf having a lock adapted to be opened by the hub after a user selects an item to be retrieved. Also, the locators may comprise an LED indicator for each bin. In addition, the bins may be adapted to be rearranged within the storage unit. In one embodiment, a second storage unit is installed adjacent to the storage unit.

The hub may comprise a computer or smart device with a network connection. The network connection may be wired or wireless. Examples of hubs may include a kiosk either installed on the storage unit or as a standalone unit, a smart phone, a tablet or a desktop, a laptop or a workstation. The network connection may be an internet connection, an intranet or a local area network. The hub may be adapted to interface with a plurality of storage units. In one embodiment, one or more storage units may be installed adjacent to the storage unit.

The system may further include a user authentication system for identifying individuals accessing the storage unit and preventing unauthorized users from retrieving items within the storage unit. In one embodiment, the user authentication system comprises a key fob system enabling a user to log-in to the hub.

The system may also further include a security camera system adapted to provide a visual signal. In one embodiment, the system further includes a facial recognition system adapted to stream, identify the user, and store visual signals obtained from said security camera system.

Accordingly, one aspect of the present inventions is to provide an autonomous crib system including (a) a storage unit having a series of shelves; (b) a plurality of bins on each shelf adapted to receive items to be stored and to be retrieved; (c) a locator associated with each bin for assisting a user with identifying a bin containing a desired item to be retrieved; (d) a counter associated with each bin for measuring the quantity of the items stored in the bin; and (e) a hub adapted to actuate the locator based on user input on an item to be retrieved and to provide item information based on quantity information received from the counters.

Another aspect of the present inventions is to provide an autonomous crib system including (a) a storage unit having a series of shelves; (b) a plurality of bins on each shelf adapted to receive items to be stored and to be retrieved, each bin comprising a tray mounted onto one or more weight sensors; (c) a locator associated with each bin for assisting a user with identifying a bin containing a desired item to be retrieved; (d) a counter associated with each bin for measuring a quantity of items based on a weight of items on the tray mounted onto one or more weight sensors; and (e) a hub adapted to actuate the locator based on user input on an item to be retrieved and to provide item information based on quantity information received from the counters.

Still another aspect of the present inventions is to provide an autonomous crib system including (a) a storage unit having a series of shelves; (b) a plurality of bins on each shelf adapted to receive items to be stored and to be retrieved, each bin comprising a tray mounted onto one or more weight sensors; (c) a locator associated with each bin for assisting a user with identifying a bin containing a desired item to be retrieved; (d) a counter associated with each bin for measuring the quantity of items based on a weight of items on the tray mounted onto one or more weight sensors; (e) a hub adapted to actuate the locator based on user input on an item to be retrieved and to provide item information based on quantity information received from the counters; and (f) a management system adapted to manage inventory within the storage unit by storing information for each item and updating information for each item based on quantity information received from the counters by the hub.

These and other aspects of the present inventions will become apparent to those skilled in the art after a reading of the following description of the embodiments when considered with the drawings.

### BRIEF DESCRIPTION OF THE DRAWINGS

FIG. 1 is a front perspective view of an autonomous crib system according to one embodiment of the present inventions;

FIG. 2 is an enlarged front perspective view of a shelf for the autonomous crib system shown in FIG. 1;

FIG. 3 is an enlarged front perspective view of a shelf with a plurality of bins for the autonomous crib system shown in FIG. 1;

FIG. 4 is an enlarged front perspective view of a shelf having two platforms with no tray mounted;

FIG. 5 is a top perspective view of a shelf with a plurality of trays mounted directly onto weight sensors according to one embodiment;

FIG. 6 is a bottom perspective view of a tray according to one embodiment;

FIG. 7 is a flowchart of a hub in communication with a plurality of storage units according to one embodiment;

FIG. 8 is a flowchart of a management system according to one embodiment;

FIG. 9 is a flowchart of a security system according to one embodiment;

FIG. 10 is a flowchart of a facial recognition system according to one embodiment; and

FIG. 11 is a flowchart of a dynamic on-hand inventory system according to one embodiment.

### DETAILED DESCRIPTION OF THE EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

The term “about,” as used herein when referring to a measurable value such as an amount of a compound, dose, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this invention belongs. As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof. As used herein, the term “consists essentially of” (and grammatical variants thereof), as applied to the compositions and methods of the present invention, means that the compositions/methods may contain additional components so long as the additional components do not materially alter the composition/method. The term “materially alter,” as applied to a composition/method, refers to an increase or decrease in the effectiveness of the composition/method of at least about 20% or more.

All patents, patent applications and publications referred to herein are incorporated by reference in their entirety. In case of a conflict in terminology, the present specification is controlling.

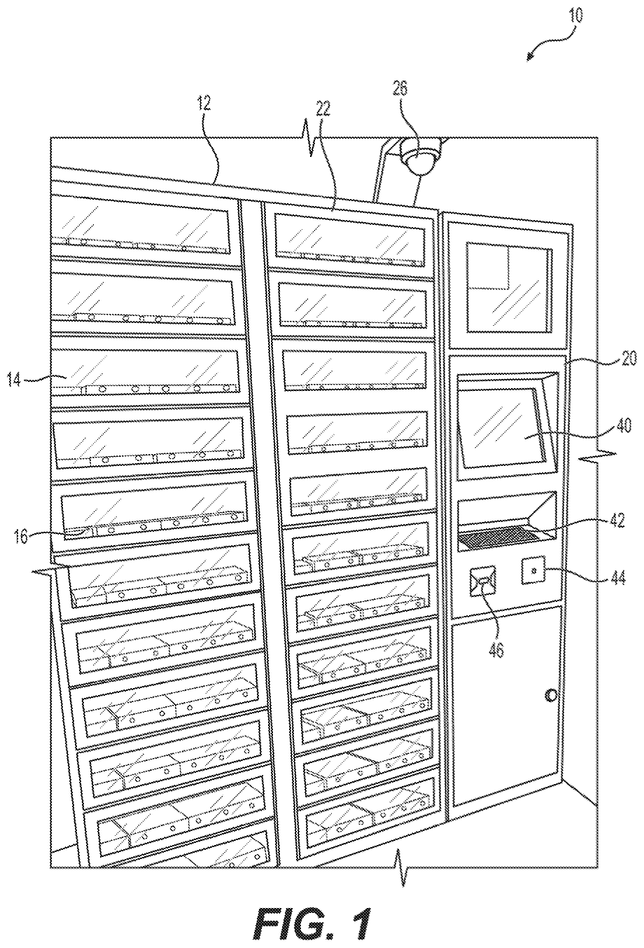

Referring now to the drawings in general and FIG. 1 in particular, it will be understood that the illustrations are for the purpose of describing a preferred embodiment of the inventions and are not intended to limit the inventions thereto. As best seen in FIG. 1, an autonomous crib system, generally designated as 10, includes a storage unit 12 having a series of shelves 14. Each shelf 14 includes a plurality of bins 16 for storing/retrieving items. A hub 20 is connected to the storage unit 12 and is adapted to provide item information contained within one or more storage units 12. The hub 20 may be installed onto the storage unit as an integrated unit or connected as a separate unit apart from the storage unit 12. In some embodiments, the hub 20 may be connected wirelessly with the storage unit.

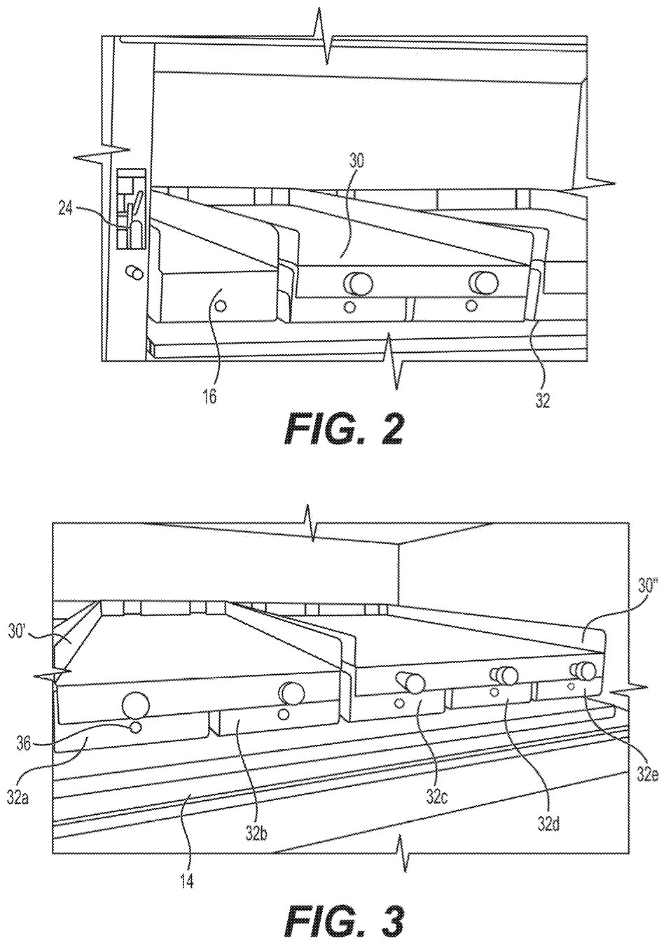

The storage unit 12 may include a door 22 for each shelf. As shown in FIG. 2, a lock system 24 may be included to secure items within the storage unit 12. A shelf 14 may be accessed by unlocking a door 22 from the hub 20.

Each bin 16 includes a counter that is adapted to measure the quantity of items stored within it. Turning to FIGS. 2 and 3, each bin 16 may be comprised of a tray 30 mounted onto one or more weight sensor assemblies 32. The tray 30 may be mounted directly onto a weight sensor 32, or as shown in this embodiment, may be mounted onto a platform 34 of a weight sensor assembly 32. FIG. 3 shows a tray 30′ adapted to be installed onto two weight sensors 32a and 32b. FIG. 3 also shows a tray 30″ adapted to be installed on three weight sensors 32c, 32d and 32e. In some embodiments, a plurality of tray sizes may be provided to the end user. For example, the trays 30 may be provided in 4 inch, 8 inch, or 12 inch sizes to be installed onto one, two or three weight sensors 32, respectively. As seen in FIG. 3, locators 36 may be associated with each bin 16 to assist a user with identifying the appropriate bin for retrieving or placing a desired item. In the embodiment shown, the locator 36 is a LED light. In some embodiments, the locator may be installed on the weight sensor 32 or on the tray 30.

Each weight sensor 32 is adapted to measure a quantity of items based on a weight of items placed on the tray 30. One example of a weight sensor 32 is a load cell. In the case of a single tray 30 mounted onto a single weight sensor 32, the weight sensor 32 is adapted to directly measure the quantity of items stored on the single tray 30. In the case where a single tray 30 is mounted onto multiple weight sensors 32, the weight sensors 32 are configured to account for the number tray 30 mounted thereof to determine the quantity of items stored on the tray 30. For example, if a tray 30′ is mounted onto weight sensor 32a and 32b, then the combined load of the items as measured by weight sensors 32a and 32b is determinant of the number of items stored onto the tray 30′.

Each bin 14 is calibrated so that an exact item count can be determined by the hub 20 as measured by the weight sensor 32. For example, when an item is removed from a particular bin 14, the inventory for the number of items within that bin is updated accordingly. The bins 14 are also adapted to detect when a number of items within a bin is below a minimum number. Furthermore, the bins 14 may also be adapted to detect when an item is misplaced in an incorrect bin.

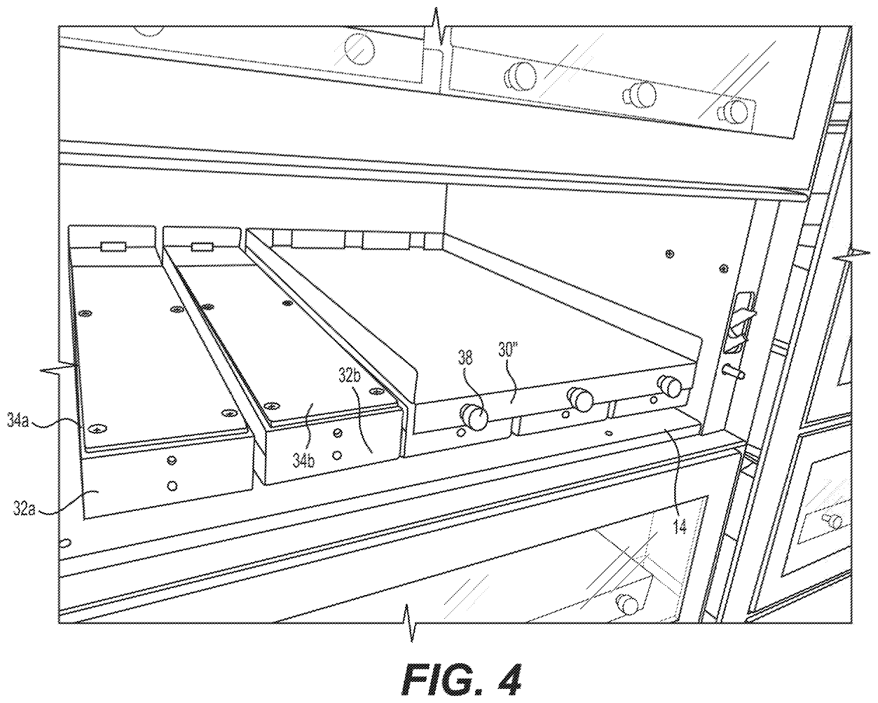

FIG. 4 shows weight sensors 32a and 32b with no trays mounted. Trays 30 are designed to be mounted and unmounted by the user, so that the user can easily rearrange the trays 30 according to the user's inventory needs. In the embodiment shown in FIG. 4, fastener 38 is used to mount the tray 30 onto weight sensor 32. As the user's inventory changes, the tray 30 of a weight sensor 32 can be unmounted to accommodate another tray 30′ of a different size.

For example, a shelf 14 may be originally configured to be comprised of six weight sensors 32 each having a tray 30 mounted to create a total of six bins 16. The number of bins 16 on a shelf 14 may be reduced to accommodate inventory items that may not fit onto a single tray 30. In such cases, two or more trays 30 may be unmounted from their respective weight sensors 32, and a larger tray 30 may then be mounted on top of the two or more weight sensors 32. In one instance, two weight sensors 32a and 32b may have their single unit trays 30 removed (as seen in FIG. 4) and subsequently have a larger tray 30′ adapted to fit over two weight sensors be installed (as seen in FIG. 3). Alternatively, larger trays may also be unmounted from the weight sensors 32 to accommodate small inventory items and create more bins 16 per shelf 14.

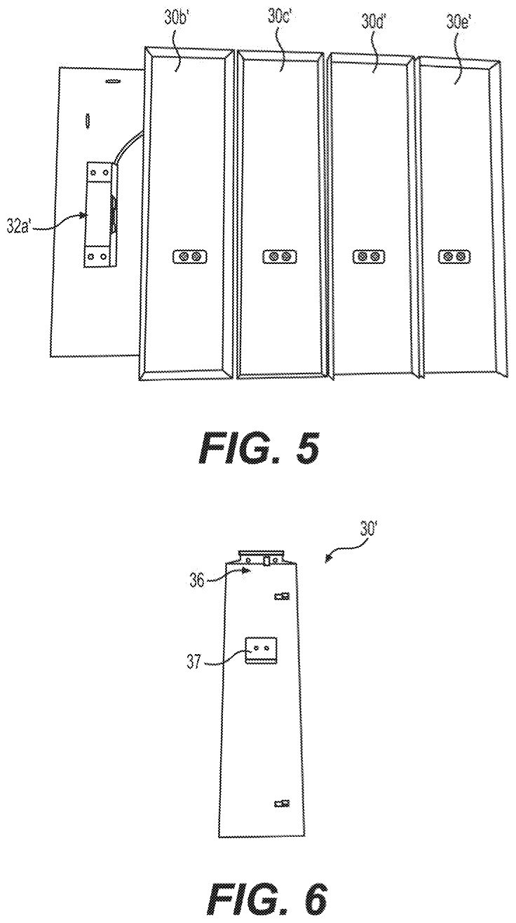

FIG. 5 illustrates another embodiment wherein one or more trays 30′ may be mounted onto weight sensors 32′ directly without a platform 34. Weight sensor 32a′ is shown without a tray 30′ installed for clarity. As seen in this embodiment, the weight sensor 32′ comprises a load cell. Trays 30b′, 30c′, 30d′, and 30e′ are each mounted onto a weight sensor (obstructed from view). FIG. 6 shows a bottom view of a tray 30′ having holes 37 for mounting onto the weight sensor 32′. In this embodiment, the locator 36 installed onto the tray 30′.

The hub 20 is adapted to communicate with and manage one or more storage units 12. Each storage unit may be installed at the same facility, different facilities or may be located offsite. The hub 20 may be located onsite with one or more other storage units, or may be located offsite away from the storage units. The hub 20 may be a computer or device with a network connection. The network connection may be wired or wireless. Examples of hubs may include a kiosk either installed on a storage unit or as a standalone unit, a smart phone, a tablet or a desktop, a laptop or a workstation. The network connection may be an internet connection, an intranet or a local area network. The storage unit 12 may further include a wired or wireless network connection to communicate with the hub 20.

An example of a hub 20 comprising a kiosk including a display 40 and an input device is shown in FIG. 1. The input device may be a touchscreen on the display 40 and/or a keyboard 42. Other input devices may also be used, including a trackball and mouse. A user authentication system may also be provided to prevent unauthorized access to the items stored in the storage unit 12 or data contained within the hub 20. The user authentication system may comprise one or more methods for determining a user's identity. In the embodiment shown, a near field communication system such as a key fob sensor 44 may be installed onto the hub 20. A card reader 46 is also provided to scan employee badges as another means of authentication. Other possible access control sensors may include fingerprint and retinal scanners as well as a facial recognition system.

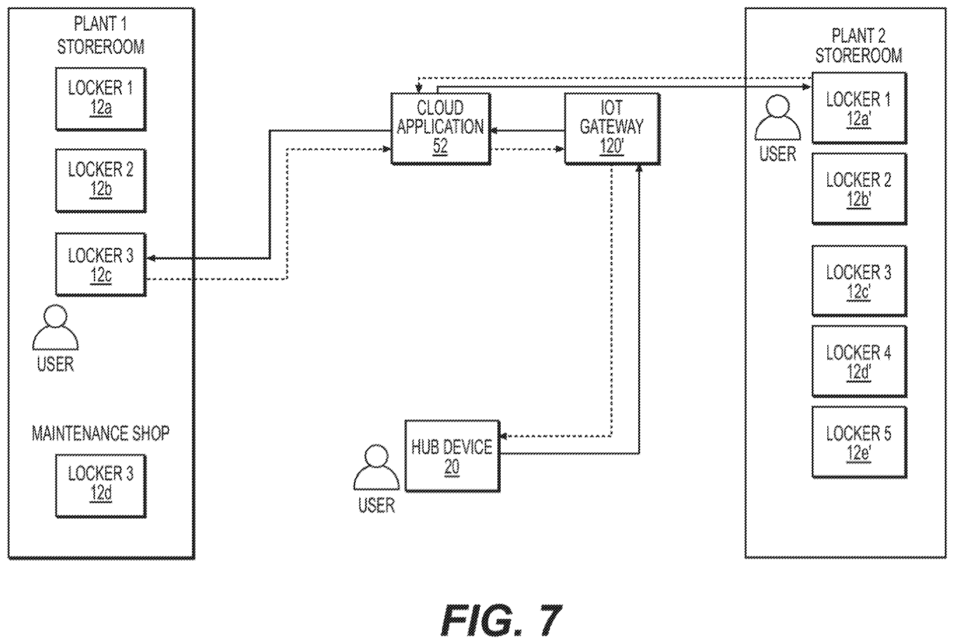

FIG. 7 provides an example of a user interacting with a hub 20 to access one or more storage units 12. A hub 20 may include any smart device with internet access, including but not limited to a phone, tablet, computer or kiosk. In the example provided, the hub 20 is running a software application that is in communication with a management system 50. The software may display all storage units 12 that the user is permitted access to and additional information associated with each storage unit 12, including all of the items stored in each storage unit 21. These items may be sold by different distributors. The user can select to issue, return, cycle count or put away a SKU from the storage unit through the software running on the hub 20. The user may be prompted to enter a user ID, quantity, allocation codes (e.g., work orders, cost center codes, department, reason for use) before sending a request through the hub 20.

A user logged into the hub 20 can send a request and access storage units 12 in multiple areas of the plant; for example, storage units 12a-d at Plant 1 and/or storage units 12a′-e′ at Plant 2. The hub 20 may be used to open storage units remotely by a user for other local users without permission level. It may also be used to open locker doors 22 where the user is physically located. The hub may communicate with the storage unit 12 wirelessly by sending requests to open doors 22 without the user needing to be directly in front of the storage unit 12. The user may also send requests to an unlimited number of storage units.

Requests sent by the user from the hub 20 may be sent to an IoT gateway 120. The request may contain a unique identifier that is assigned to a specific storage unit, the door number and/or location number where an item is stored, and/or the user's ID number. The IoT Gateway 120 may send this information to cloud application 52 for processing to identify which locker, doors and location the request should be sent to.

Cloud application 52 processes the request and sends a command to the requested storage unit 12 to open the requested door(s) where the requested item is kept. The cloud application 52 may also signal to turn on the locator where the requested item is stored. The hub may also be adapted to enable users to send a request to issue multiple items. The requested items may be from the same storage unit or stored in different storage units that may not be located in the same geographic space; for example, a user may request for a first item in Plant 1 and a second item in Plant 2.

As the request received from the cloud application 52 is executed by a storage unit 12, the door where the requested item is kept will open. The user can either take, put back or count the inventory. When the user closes the door, the transaction will be complete. The local counter of a storage unit will weigh the items in the locker before the door opens and after the door is closed to determine an item count. The item count information may be sent back to the cloud application 52 where it may be further processed. If the actual weight changes are equal to the expected weight changes, then the transaction will be logged as a success. If the actual weight changes are not equal to the expected weight changes, then the transaction will be logged as a failure and users may be notified.

The IoT Gateway 120 may communicate transaction results to a user's hub device 20. These results may include displaying discrepancies in the transaction, communicating a successful transaction, showing the user what the new on-hand inventory is, or prompting the user to order more inventory based on a dynamic on-hand inventory system 56 (further described below).

The autonomous crib system 10 is configured by loading inventory data such as part number, location and inventory threshold levels into a management system for the hub 20. Each item is assigned to a specific bin 14 and to one or many weight sensors 32, which hold the tray 30 and inventory product. The weight sensors 32 monitor inventory levels. When an inventory level falls below the minimum quantity stored in the hub 20, the hub 20 will add this item to the end-users replenishment list along with a recommended reorder quantity.

The hub 20 is also responsible for controlling a plurality of doors 14 for access to the bins 16 within the storage unit 12. These doors 14 are adapted to be opened once a user selects an item that is stored in the storage unit 12 on the display 40. For example, the user selects an item on the hub 20 and enters other transaction data as specified by a site administrator. The hub 20 sends a signal to the corresponding door 14 where the item is located and the locking mechanism 24 will prompt a spring release to slowly push the desired door 14 open. Locator(s) 36 associated with the appropriate bin 16 (e.g., mounted on tray 30 or weight sensor 32) will turn on to indicate the exact location of the item being issued. Once the user takes the item and closes the door 14, the weight sensors 32 for the particular tray 30 that the item was stored will send a signal to the hub 20 and the hub 20 will calculate the new inventory levels of the items that are located in that bin 16 and calculate the items and quantities that have been taken by the user. If the hub 20 indicates that an item has been removed from the compartment that was not originally issued by the hub 20, the hub 20 can send a discrepancy alert to an assigned site administrator who can verify if an item was taken without being issued from the hub 20.

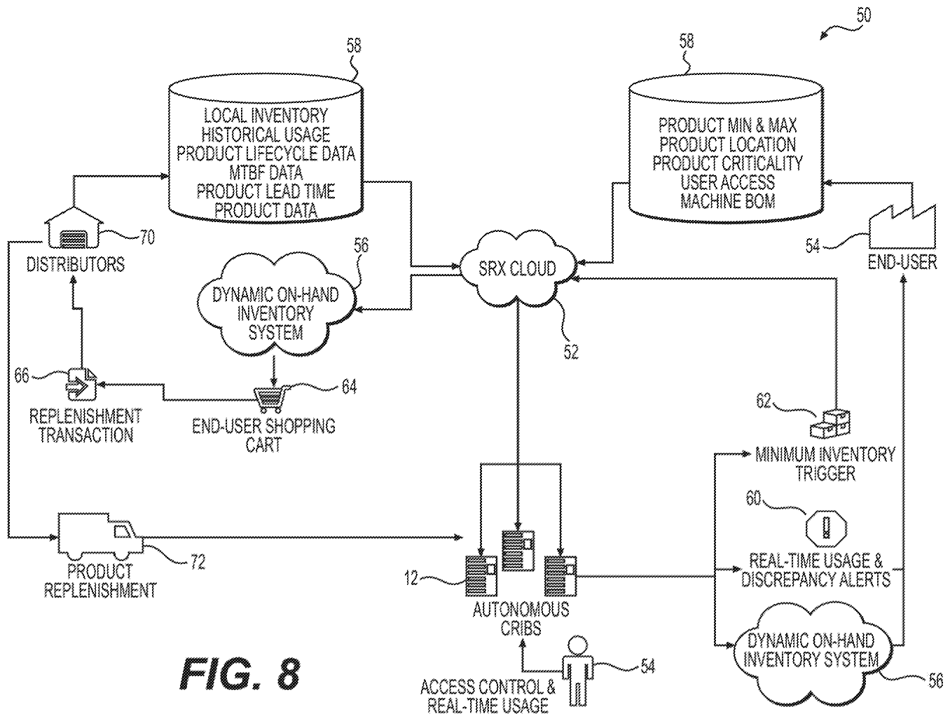

One example of a management system 50 is provided by FIG. 8. A cloud database 52 is provided for distributors 70 and customers 54 to add, edit and store inventory specific data 58. Data 58 may be accessed from the cloud database 52 using a web-based user interface or through electronic data transfers. This data 58 can be updated manually by a user 54 or can be automatically updated periodically: for example, an hourly, daily or weekly schedule. When an end-user 54 needs to return or issue a product from the storage unit 12, they must first authenticate themselves via one of the access control sensors. The management system 50 may enable end-users to have the ability to control user access of an entire storage unit 12 or certain shelves 14 in the web-based user interface.

There are multiple triggers that may be generated by the user 54. For example, an email or SMS system can be setup to generate one or more alerts 60, including product usage alerts, user alerts, dollar value alerts, etc. The user 54 can also request to generate an inventory audit either at the hub 20 directly at its physical location or via the web-based user interface. The hub 20 will send a message to a dynamic on-hand inventory system 56. If a user 54 issues an item causing the current on hand inventory level to fall below the minimum level stored in the hub 20, the hub 20 will send a minimum inventory trigger 62 to the cloud database 52, prompting the dynamic on hand inventory system 56.

As shown in FIG. 8, once an item has been processed through the dynamic on-hand inventory system 56 it will be added to the end-user's shopping cart list 64. The end user can edit and submit this list 64 to create a replenishment transaction 66. The list 64 is then sorted and sent to the distributor 70 assigned to each item on the submitted list 64. The distributors 70 can process the transaction 66 from the end-user and update the data in the cloud database 52. After processing the transaction(s) 66, distributor(s) 70 replenish the inventory 72 in the autonomous crib 12. After replenishing an item in the autonomous crib 12, the hub 20 will call the weight sensors 34 in the shelf 14 and send a minimum inventory messages 62 for any item for which the current on hand inventory is lower than the defined minimum.

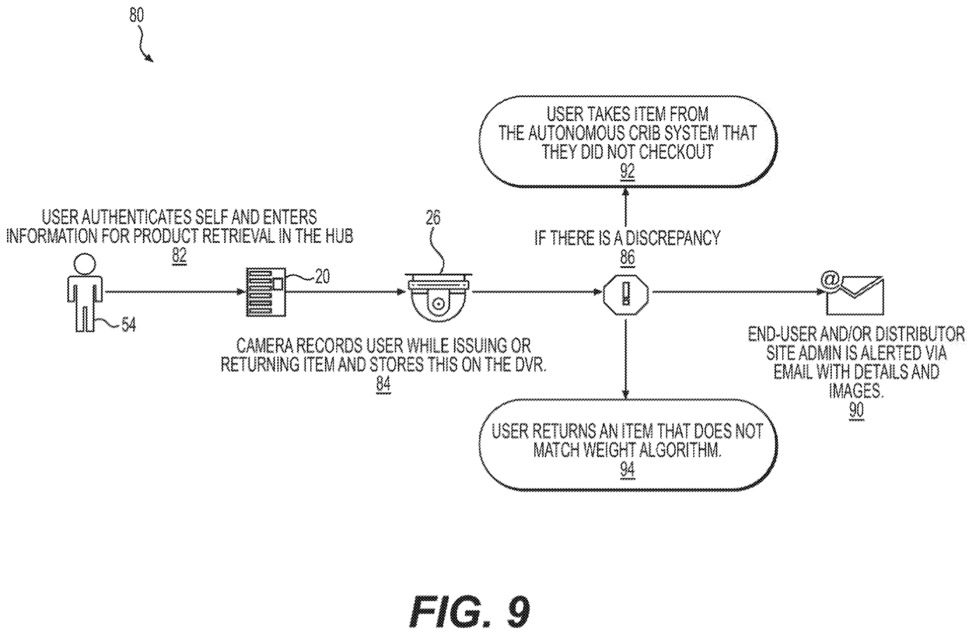

One example of a security camera system 80 for accessing the management system 50 is provided in FIG. 9. A user 54 is authenticated and enters information for retrieving a product 82 in the hub 20. A camera 26 (also seen in FIG. 1) may be provided to record the user while issuing or returning an item 84. The visual feed provided by the camera 26 may be stored on a digital video recorder. If there is a discrepancy 86 based on the actions of user 54, the end-user and/or distributor site administrator is alerted via an email with details and images 90. One example of a discrepancy may be when a user 54 returns an item that does not match the weight algorithm 94. Another example may be when a user 54 takes an item from the storage unit 12 that the user 54 did not checkout at the hub 92.

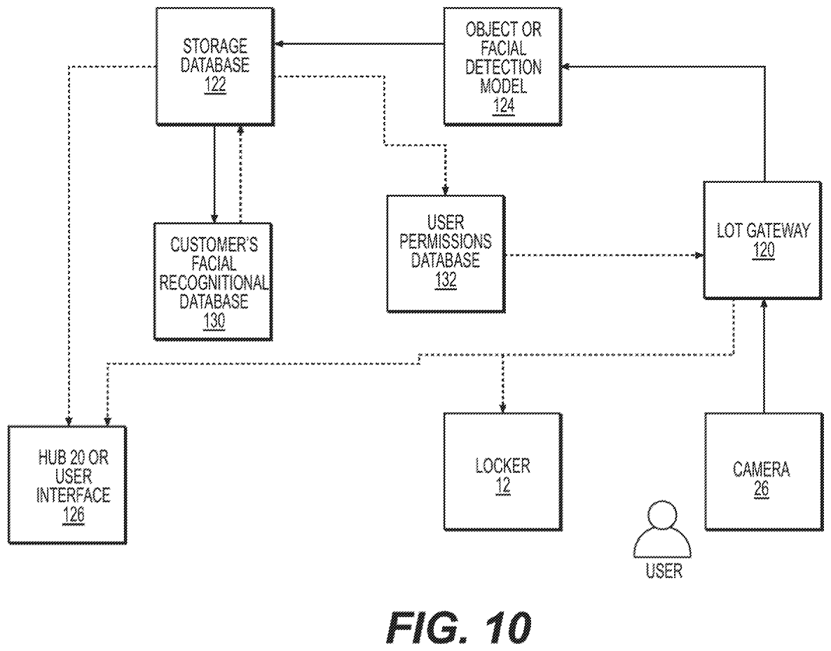

In some embodiments, the security camera system may further include a facial recognition system for identifying users. The facial recognition system is adapted to stream the visual feed provided by the camera 26 into a cloud service database and run through a facial recognition model and compared against a database with user images to identify the user based on facial attributes. FIG. 10 provides one example of a facial recognition system. A camera 26 having a unique identifier may be associated with a specific storage unit 12 through the management system 50. The camera 26 may be programmed to continuously record a visual feed or begin recording upon occurrence of a certain event; for example, when motion is detected near the vicinity of the camera 26 or when a door 22 is opened.

The visual signal captured by the camera 26 is sent to an Internet-of-Things (“IoT”) gateway 120 along with the unique identifier of the camera associated with a storage unit where the camera may be mounted. The IoT hub processes the initial visual signal and unique identifier, then sends the captured visual signal to an object detection or facial recognition system 124. The facial recognition system 124 employs a complex rating system used to determine whether the visual signal contains a human. If the facial recognition system 124 identifies a human within the captured visual signal, an image or short video clip may be captured and delivered to the storage database 124. The processed image may be stored on the storage database 124 for a pre-determined time frame (e.g., for a day or week). The image may be posted to a hub 20 or another user interface 126. In some embodiments, the processed visual signal captured by the camera 26 may be stored after processing to a storage database 122 associated with a storage unit and/or customer.

In one embodiment, the stored image with a detected human may be compared against a facial recognitional database 130 populated with images of user faces and associated user data for each image. Using a facial recognition algorithm, the human in the stored image may be identified. For example, the facial recognition system may be used as an access control system. A user, such as an employee, may approach the camera 26 and the facial recognition system may identify the user from a facial recognitional database 130 and then grant appropriate access of a storage unit 12 associated with camera 26 to that user from the user permissions database 132.

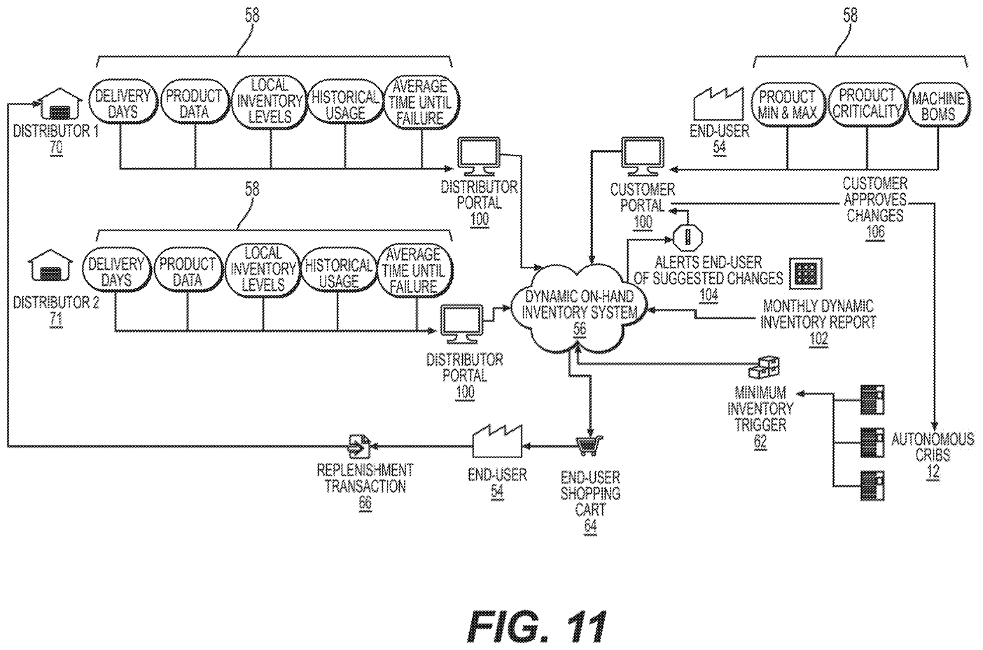

FIG. 11 provides one example of a dynamic on-hand inventory system 56 for the management system 50 that is cloud-based. Many variables may factor into the dynamic inventory calculations for the dynamic on-hand inventory system 56. Distributors 70 and 71 and end-users 54 can populate this data 58 through user interfaces and electronic data transfers 100. The dynamic on-hand inventory system 56 merges the data 58 from the end-user 54, distributor(s) 70 (and 71) and the real-time inventory usage data captured by the hub to calculate a recommended minimum, maximum and reorder quantity. The recommended minimum and maximum levels aim to give the end-user 54 the best amount of inventory needed to keep on site. The recommended reorder quantity is calculated based on the recommended maximum level and the end-user's current on-hand inventory level provided by the hub.

There may be various triggers that will prompt the dynamic on hand inventory system 56. One example of a trigger may be a dynamic inventory report 102 generated at an interval. For example, the interval may be each month. At each interval, the hub 20 requests information from the weight sensors and calculates the current inventory levels for all of the items stored in the autonomous crib 12. The hub 20 will send this data to the cloud-based dynamic on-hand inventory system 56 which will take a snapshot of the variables 58 inputted by the distributor(s) 70 (and 71) and customer 54 to generate a new recommended minimum and maximum level for each item. The dynamic inventory system 56 generates a report 104 showing items' current inventory levels, current minimum and maximum levels and new recommended min and max levels. End-users 54 have the ability to accept the recommended minimum and maximum. If the new minimum and maximum levels are accepted 106, these levels will be stored in the hub for the particular items. Any surplus inventory caused by a lower minimum or maximum level can be eventually depleted through usage, or in certain cases, returned to the distributors 70 (or 71) to prevent dead inventory.

In cases where the recommended minimum is greater than the current inventory level, the hub will prompt a minimum inventory trigger 62. The minimum inventory message 62 is another trigger that may prompt the dynamic on-hand inventory system 56. When the current inventory level of an item falls below the minimum quantity, a message 56 is sent to the dynamic on-hand inventory system 56 prompting a calculation of a new recommended minimum and maximum. The dynamic on-hand inventory system 56 calculates the recommended reorder quantity based on the current inventory level of the item and the recommended maximum. The item(s) that generate the minimum inventory message 56 is then added to the end-user's shopping cart 64 along with the recommended reorder quantity and the new recommended minimum and maximum. An end-user 54 can view a shopping cart list 64 that includes products procured from one or many distributors. Once the end-user 54 reviews, edits and submits the shopping cart 64, the product transaction data 66 is sent to the distributor assigned to each particular item.

Certain modifications and improvements will occur to those skilled in the art upon a reading of the foregoing description. By way of example, the dimensions of the individual storage units may vary depending on the size of items or the amounts of items. Furthermore, it is understood that the cloud applications may be different cloud-based databases that may form a uniform cloud environment to an end user, and that the IoT gateways for accessing the cloud applications may likewise differ. It should be understood that all such modifications and improvements have been deleted herein for the sake of conciseness and readability but are properly within the scope of the following claims.

We claim:

1. An autonomous crib system comprising:
(a) a storage unit having a series of shelves;
(b) a plurality of bins on each shelf adapted to receive items to be stored and to be retrieved;
(c) a locator associated with each bin for assisting a user with identifying a bin containing a desired item to be retrieved;
(d) a counter associated with each bin for measuring the quantity of the items stored in said bin; and
(e) a hub adapted to actuate said locator based on user input on an item to be retrieved and to provide item information based on quantity information received from said counters.

2. The autonomous crib system of claim 1 further including a management system adapted to manage inventory within said storage unit by storing information for each item and updating information for each item based on quantity information received from the counters by the hub.

3. The autonomous crib system of claim 2, wherein said management system manages inventory for a plurality of storage units.

4. The autonomous crib system of claim 2 further including a dynamic on-hand inventory system adapted to calculate an on-hand inventory quantity of an item on an interval based on a plurality of variables.

5. The autonomous crib system of claim 4, wherein said plurality of variables is selected from an item usage history, an item stock from a vendor, a product criticality to a customer, a lead time, an average time until failure for said item, an average number of delivery days, and combinations thereof.

6. The autonomous crib system of claim 4, wherein said dynamic on-hand inventory system is adapted to calculate the reorder quantity when said counter indicates a quantity of an item is below said on-hand inventory quantity.

7. The autonomous crib system of claim 4, wherein said dynamic on-hand inventory system is adapted to retrieve and manage data from a plurality of vendors.

8. The autonomous crib system of claim 7, wherein said dynamic on-hand inventory system is integrated with a vendor system for sending and retrieving data via an application programming interface.

9. The autonomous crib system of claim 7, wherein said item is automatically transacted based on said on-hand inventory quantity when said counter indicates the quantity of an item is below said on-hand inventory quantity.

10. The autonomous crib system of claim 1 further including a lock system adapted to secure items within said storage unit.

11. The autonomous crib system of claim 10, wherein said lock system comprises a door on each shelf having a lock adapted to be opened by said hub after a user selects an item to be retrieved.

12. The autonomous crib system of claim 1, wherein said locators comprise an LED indicator for each bin.

13. The autonomous crib system of claim 1, wherein said bins are adapted to be rearranged within said storage unit.

14. The autonomous crib system of claim 1, wherein said hub comprises a smart device with a network connection selected from the group comprising a kiosk installed on said storage unit, a standalone kiosk, a desktop, a laptop, a workstation, a smart phone or a tablet.

15. The autonomous crib system of claim 14, wherein said hub is adapted to interface with a plurality of storage units.

16. The autonomous crib system of claim 14 further including a user authentication system for identifying individuals accessing said storage unit and preventing unauthorized users from retrieving items within said storage unit.

17. The autonomous crib system of claim 16, wherein said user authentication system comprises a key fob system enabling a user to log-in to said hub.

18. The autonomous crib system of claim 14 further including a security camera system adapted to provide a visual signal.

19. The autonomous crib system of claim 18 further including a facial recognition system adapted to stream, identify and store said visual signals obtained from said security camera system.

20. An autonomous crib system comprising:
(a) a storage unit having a series of shelves;
(b) a plurality of bins on each shelf adapted to receive items to be stored and to be retrieved, each bin comprising a tray mounted onto one or more weight sensors;
(c) a locator associated with each bin for assisting a user with identifying a bin containing a desired item to be retrieved;
(d) a counter associated with each bin for measuring a quantity of items based on a weight of items on the tray mounted onto one or more weight sensors; and
(e) a hub adapted to actuate said locator based on user input on an item to be retrieved and to provide item information based on quantity information received from said counters.

21. The autonomous crib system of claim 20, wherein said hub is adapted to display an exact quantity of items stored within each bin based on said weight of items on said tray.

22. The autonomous crib system of claim 21, wherein said hub is adapted to determine whether a misplaced item is placed onto said bin.

23. The autonomous crib system of claim 21, wherein said hub is adapted to detect a low item quantity when said weight of items as determined by said weight sensor is below a threshold number of items.

24. The autonomous crib system of claim 23, wherein said hub relays said low item quantity from said weight sensor to said management system.

25. The autonomous crib system of claim 20, wherein said tray is adapted to be unmounted from said weight sensor and adapted to be mounted onto another one or more weight sensors within said storage unit.

26. The autonomous crib system of claim 20, wherein said tray is mounted onto multiple weight sensors for larger sized items.

27. An autonomous crib system comprising:
(a) a storage unit having a series of shelves;
(b) a plurality of bins on each shelf adapted to receive items to be stored and to be retrieved, each bin comprising a tray mounted onto one or more weight sensors;
(c) a locator associated with each bin for assisting a user with identifying a bin containing a desired item to be retrieved;
(d) a counter associated with each bin for measuring the quantity of items based on a weight of items on the tray mounted onto one or more weight sensors;
(e) a hub adapted to actuate said locator based on user input on an item to be retrieved and to provide item information based on quantity information received from said counters; and
(f) a management system adapted to manage inventory within said storage unit by storing information for each item and updating information for each item based on quantity information received from the counters by the hub.

28. The autonomous crib system of claim 27, wherein said management system manages inventory for a plurality of cribs.

29. The autonomous crib system of claim 27 further including a dynamic on-hand inventory system adapted to calculate an on-hand inventory quantity of an item on an interval based on a plurality of variables.

30. The autonomous crib system of claim 29, wherein said plurality of variables is selected from an item usage history, an item stock from a vendor, a product criticality to a customer, a lead time, an average time until failure for said item, an average number of delivery days, and combinations thereof.

31. The autonomous crib system of claim 29, wherein said dynamic on-hand inventory system is adapted to calculate the reorder quantity when said counter indicates a quantity of an item is below said on-hand inventory quantity.

32. The autonomous crib system of claim 29, wherein said dynamic on-hand inventory system is adapted to retrieve and manage data from a plurality of vendors.

33. The autonomous crib system of claim 32, wherein said dynamic on-hand inventory system is integrated with a vendor system for sending and retrieving data via an application programming interface.

34. The autonomous crib system of claim 32, wherein said item is automatically transacted based on said on-hand inventory quantity when said counter indicates the quantity of an item is below said on-hand inventory quantity.

35. The autonomous crib system of claim 27 further including a lock system adapted to secure items within said storage unit.

36. The autonomous crib system of claim 35, wherein said lock system comprises a door on each shelf having a lock adapted to be opened by said hub after a user selects an item to be retrieved.

37. The autonomous crib system of claim 27, wherein said locators comprise an LED indicator for each bin.

38. The autonomous crib system of claim 27, wherein said bins are adapted to be rearranged within said storage unit.

39. The autonomous crib system of claim 27, wherein said hub comprises a smart device with a network connection selected from the group comprising a kiosk installed on said storage unit, a standalone kiosk, a desktop, a laptop, a workstation, a smart phone or a tablet.

40. The autonomous crib system of claim 39, wherein said hub is adapted to interface with a plurality of storage units.

41. The autonomous crib system of claim 40 further including a user authentication system for identifying individuals accessing said storage unit and preventing unauthorized users from retrieving items within said storage unit.

42. The autonomous crib system of claim 41, wherein said user authentication system comprises a key fob system enabling a user to log-in to said hub.

43. The autonomous crib system of claim 41 further including a facial recognition system adapted to stream, identify and store said visual signals obtained from a security camera system.

44. The autonomous crib system of claim 27, wherein said hub is adapted to display an exact quantity of items stored within each bin based on said weight of items on said tray.

45. The autonomous crib system of claim 44, wherein said hub is adapted to determine whether a misplaced item is placed onto said bin.

46. The autonomous crib system of claim 44, wherein said hub is adapted to detect a low item quantity when said weight of items as determined by said weight sensor is below a threshold number of items.

47. The autonomous crib system of claim 46, wherein said hub relays said low item quantity from said weight sensor to said management system.

48. The autonomous crib system of claim 27, wherein said tray is adapted to be unmounted from said weight sensor and adapted to be mounted onto another weight sensor within said storage unit.

49. The autonomous crib system of claim 27, wherein said tray is mounted onto multiple weight sensors for larger sized items.
